(19) United States
(12) Patent Application Publication
(10) Pub. No.: US 2016/0247156 A1
(43) Pub. Date: Aug. 25, 2016

(54) SECURE TRANSACTION PROCESSING THROUGH WEARABLE DEVICE

(71) Applicant: EBAY INC., San Jose, CA (US)

(72) Inventors: Michael Hwang, Sunnyvale, CA (US); Michael Voege, Santa Clara, CA (US); Michael McKay, Los Altos, CA (US)

(21) Appl. No.: 14/628,174

(22) Filed: Feb. 20, 2015

(51) Int. Cl. G06Q 20/40; G06Q 20/38; G06Q 20/32; G06K 19/073

(52) U.S. Cl. CPC G06Q 20/4014; G06K 19/07309; G06Q 20/405; G06Q 20/3829; G06Q 20/3278

(57) ABSTRACT

Systems and methods are disclosed for provisioning resources from a first user account to a second user and wearable device for use in a secure transaction. The system may include an electronic payment system having an account for a first user who may allocate funds to a second user's wearable device for utilization in an electronic payment transaction. The recipient and the recipient's device are authenticated to the electronic payment system. The first user may establish automated allocation rules for funding the second user's device and restrictions on the use of the funds. The wearable device may be a bracelet including a sensing element detecting when the recipient is wearing the device, a secure element storing authentication information and a transaction module facilitating the secure transaction and disabling the bracelet when the sensing element detects the bracelet is not properly secured to the recipient.

### TECHNICAL FIELD

The present application relates generally to mobile devices and more specifically to systems and methods for processing secure transactions through wearable technology and devices.

### BACKGROUND

Mobile devices such as smart phones and smart watches are enjoying widespread popularity. Some of these devices store sensitive personal information and enable functions that could be harmful to the user if the device was stolen, lost or otherwise accessed by an unauthorized user. For example, a smartphone may store the user's online passwords and credit card information used for online purchases. A smartphone may also be used in place of a credit card to make an electronic payment at a merchant through a digital wallet or electronic payment service. Many devices used for secure transactions include specialized hardware to authenticate a user, such as through biometric identification, and protect the confidential payment information. For example, a tamper resistant card or chip may be used that provides for secure storage of sensitive information and control over secure electronic payment transactions. With the widespread adoption of specialized mobile devices, including wearable technology such as smart watches, fitness trackers and clothing that monitor fitness activity, it is not always necessary or desirable for a user to carry additional devices, such as a smartphone.

### BRIEF DESCRIPTION OF THE DRAWINGS

FIG. 1 is a flow chart illustrating an embodiment of an exemplary secure transaction process;

FIG. 2 is an embodiment of an exemplary network system suitable for processing a secure transaction;

FIG. 3 is an embodiment of an exemplary network system suitable for processing a secure transaction;

FIGS. 4a and 4b are flow diagrams illustrating an embodiment of an exemplary device authentication process;

FIG. 5 is a flow diagram illustrating an embodiment of an exemplary electronic payment process;

FIGS. 6a-d illustrate an exemplary bracelet device suitable for operating as a secondary device in certain embodiments described herein; and

FIG. 7 is an embodiment of an exemplary computer system suitable for implementing one or more components in FIGS. 2, 3, and 6.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for processing secure transactions, such as electronic payments transactions, through a wearable devices. Systems suitable for practicing methods of the present disclosure are also provided.

In various embodiments, a master device, such as a smartphone, is adapted to perform a secure transaction or function, such as making an electronic payment through a merchant point of sale device. The user of the master device may allocate resources (e.g., money) and permitted actions a secondary device, such as a smart bracelet or smart watch. In various embodiments the user and master device access a user account. Through the master device, the user may allocate account resources to a secondary device and establish restrictions on the utilization of the allocated resources. For example, the user may transfer funds from an electronic payment account to a secondary device by manually tapping the master device against a secondary device, by setting up a certain amount limits on the user's home computer which enables a wearable device in the vicinity of computer, by configuring automatic allocation rules, or by transferring funds through an account management application. In exemplary embodiments, the automatic allocation of funds may include a periodic payment to the user of a secondary device (e.g., a weekly allowance) or a context or event based transfer based on location, time, date or the occurrence of an event. In one embodiment, personal information (e.g., fitness activity or school grades) associated with the secondary user is tracked electronically and accessed through the account. Using the tracked electronic information, the account owner may define events that trigger the allocation of additional account resources (e.g., getting good grades or achieving fitness goals). In various embodiments, the account owner may also set restrictions on the use of allocated funds, which may include restrictions based on location, time, spending limits and use and status of the secondary device.

In one embodiment, the first user is a parent and the second user is a child. The parent has an account with an electronic payment processing service. The parent may award the child an allowance from the parent's account that is automatically allocated to the child and accessible through the child's mobile device, such as a smart watch or bracelet. The parent may also set up context-based rules for allocating the allowance based on the child meeting certain goals. For example, the amount of the allowance may depend on the child's grades in school or fitness activity recorded on an electronic device. The parent may also set up context-based restrictions on the child's spending, which may be, for example, location based and time based restrictions. The child's mobile device, may include additional security features to protect the information and the resources allocated to the child. For example, in one embodiment, the child wears the bracelet when resources are allocated and the resources information is deleted and disabled if the child takes off the bracelet. In various embodiments, the child device may provide the parent with a method to interact with the child (such as through voice communication and messaging applications), store emergency information for the child (health information, parent contact, hospital information) and track the child's movement and location.

In another embodiment, the first user is a construction manager and the second users are contractors who work for the first user. The construction manager may enable certain contractors to buy items/materials at a hardware store, such as Home Depot, for a construction project. The construction manager may set up spending limits, restrictions on items that each contractor could purchase and locations where each contractor may spend the funds.

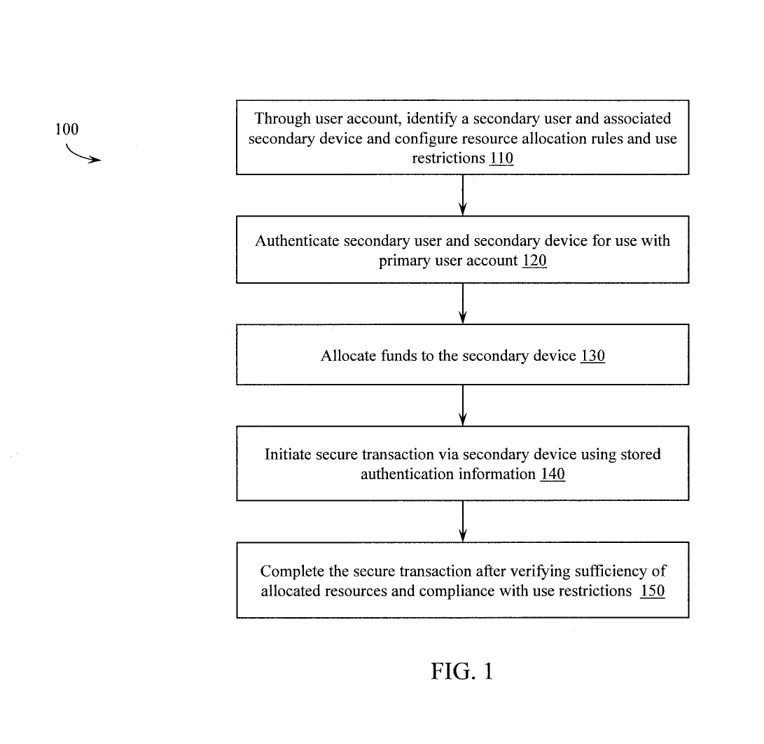

FIG. 1 is a flow chart 100 illustrating an embodiment of an exemplary secure transaction process. In step 110, a primary user operates a master device, such as a smart phone, which is authenticated for secure transactions through a service provider. The primary user accesses a corresponding master account managed by the service provider (e.g., PayPal or a bank), and identifies a secondary user and associated secondary device that may be used to access certain services offered by the service provider. In various embodiments, the secondary user and device may be identified manually by the primary (e.g., “add friend”), through family account features, by locating devices in vicinity, in response to a request received from a user and through social media or contacts lists. The primary user may configure resource allocation rules and use restrictions for the services available to the secondary user and device through the primary user's account. In various embodiments, the service provider is an electronic payment processing service and the resource allocation rules may include manual transfer of user account funds to a secondary device via the master device, automatic allocation of funds from the user account to a secondary device on a periodic basis, context-based funds transfers and event-based funds transfer rules. In various embodiments, the use restrictions may include time, location, context and other restrictions on the use of transferred funds.

In step 120, the secondary user and secondary device are authenticated for use with the master account. In various embodiments, user authentication may include user name and password, biometric authentication (e.g., fingerprint scan) or other user authentication as desired. Device authentication may include a unique device identifier, shared encryption keys, a unique token, and other authentication techniques and protocols. In one embodiment, the secondary device is adapted to facilitate an electronic payment (e.g., through an application associated with the service provider) and receives a payment token from the master device, which is associated with the master account, and the secondary device. In various embodiments, one or more tokens may be used, the tokens may be single use or multi-use, and the tokens may be generated and transmitted to the secondary device by the master device or the service provider.

After the secondary device is authenticated for use with the master account, the primary user and service provider may allocate funds to the secondary device in step 130. In various embodiments, resources may be allocated via instruction by the primary user, through context-specific interactions (e.g., tapping the master device to the secondary device to initiate funds transfer) or in accordance with resource allocation rules established by the primary user.

In step 140, the secondary user initiates a secure transaction using the stored authentication information via the secondary device. In one embodiment, the secure transaction is an electronic purchase from a merchant and the secondary device prepares and sends encrypted transaction information and token to the merchant device. The merchant forwards the transaction information to the service provider who authenticates the transaction information received from the merchant and verifies sufficient resource balance and compliance with use restrictions prior to authorizing the transaction. In one embodiment, the secondary device verifies the account balance and compliance with use restrictions prior to engaging with the merchant device, for example, by tracking resource balance and use restrictions locally on the secondary device, or requesting pre-approval for the transaction from the service provider or actual account owner.

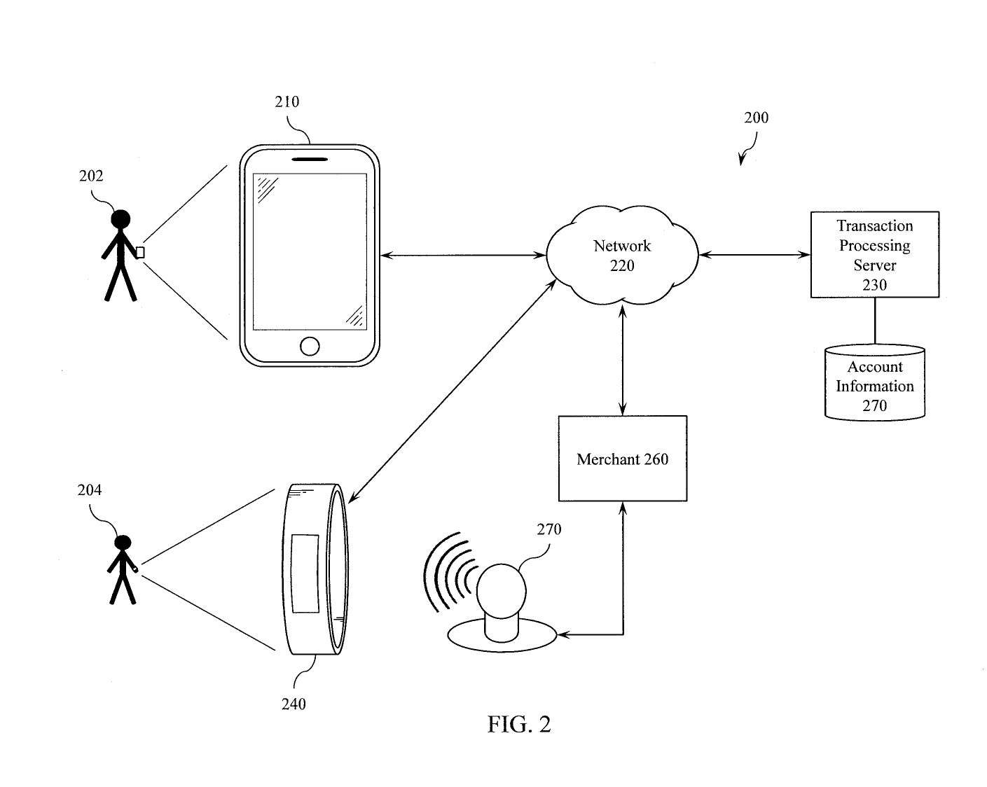

Referring to FIG. 2, an embodiment of an exemplary network system 200 suitable for processing a secure transaction will be described. As shown, system 200 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 2 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities, and communications between devices and servers may be encrypted to provide communication security

System 200 includes a primary user 202, a primary device 210, a secondary user 204, a secondary device 240, and a payment-processing server 230 in communication over a network 220. Primary device 210, secondary device 240 and payment processing server 230 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 150.

Primary device 210 may be implemented using any appropriate hardware and software configured for wired and/or wireless communication with the payment-processing server 230. In various embodiments, the primary device 110 may be implemented as a smart phone (as shown), tablet, laptop computer, personal computer, wristwatch with appropriate computer hardware resources, head mounted computer (e.g., eyeglasses with appropriate computer hardware), clothing with wearable technology with appropriate computer hardware, and/or other types of computing devices capable of transmitting and/or receiving data as described herein. Although only one user device is shown, a plurality of user devices may function similarly. Moreover, in various embodiments, one or more of the applications, processes, and/or features discussed below in reference to primary device 210 may be included in a communication device connected to primary device 210.

Secondary device 240 may be implemented using any appropriate hardware and software configured for wired and/or wireless communication with the transaction-processing server 240. In various embodiments, the secondary device 240 may be implemented as a smart bracelet (as shown), tablet, laptop computer, personal computer, wristwatch with appropriate computer hardware resources, head mounted computer (e.g., eyeglasses with appropriate computer hardware), clothing with wearable technology with appropriate computer hardware, health tracking wearable or sensor device and/or other types of computing devices capable of transmitting and/or receiving data as described herein. Although only one user device is shown, a plurality of user devices may function similarly. Moreover, in various embodiments, one or more of the applications, processes, and/or features discussed below in reference to secondary device 240 may be included in a communication device connected to secondary device 240.

The transaction processing server 230 may be maintained, for example, by an online electronic payment processing services provider and include one or more servers incorporating one or more processing applications configured to interact with master device 210 and a merchant 260. In one example, the service provider may be PAYPAL®, Inc. of San Jose, Calif., USA. Although only one server is shown, a plurality of servers and/or associated devices may function similarly.

Network 220 may be implemented as a single network or a combination of multiple networks. For example, in various embodiments, network 220 may include the Internet or one or more intranets, landline networks, wireless networks, and/or other appropriate types of networks. Network 220 may correspond to small-scale communication networks, such as a private or local area network, or a larger scale network, such as a wide area network or the Internet, accessible by the various components of system 200. In one embodiment, communications between devices and servers via the network 220 of personal, account, location and other sensitive information are encrypted to ensure confidentiality.

In an exemplary implementation of the system 200, the primary user 202 is a parent and the secondary user 204 is a child. The parent uses the master device 210, such as a smart phone, to communicate over the network 220 with the transaction-processing server 230. Through the transaction processing server 230, the parent may allocate funds from the parent's account to the child 204, and the child may utilize the secondary device 240, such as a smart bracelet as illustrated, to purchase goods or services at a merchant's point of sale terminal 270. In one embodiment, the parent 202 can establish money allocation rules to control the allocation of account funds to the child and define spending restrictions on the funds to control the child's expenditures.

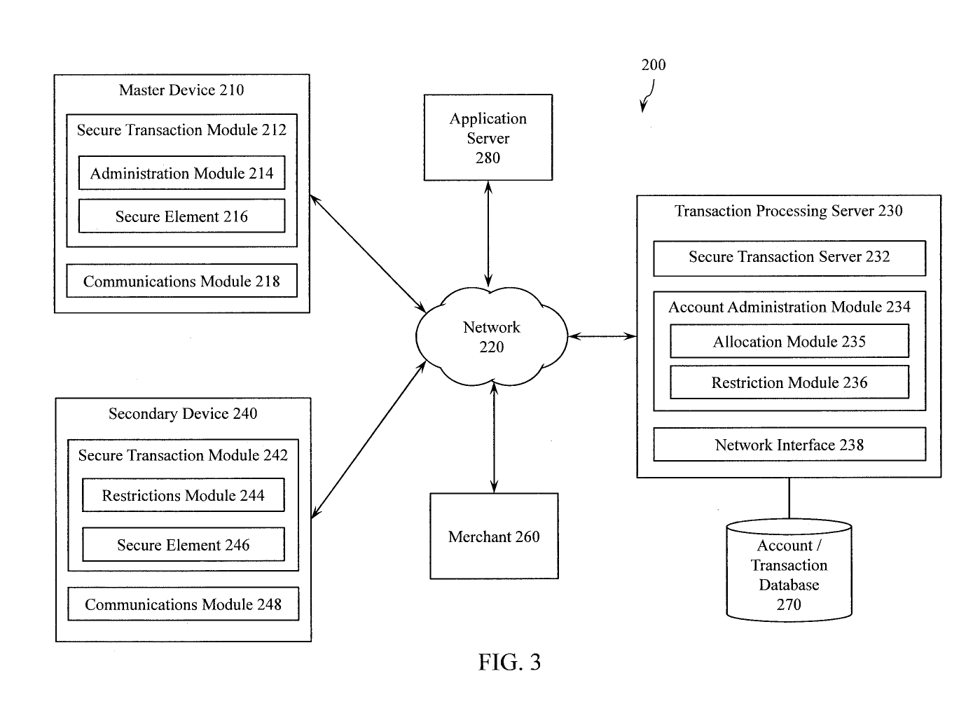

Referring to FIG. 3, an embodiment of exemplary components of the master device 210, secondary device 240 and transaction processing server 230 are described. Master device 210 comprises a secure transaction module 212 and a communication module 218. In other embodiments, primary device 210 may include additional or different modules having specialized hardware and/or software as required. Secure transaction module 212 comprises hardware components and software to facilitate a secure transaction through the transaction-processing server 230. In one embodiment, the secure transaction module 212 facilitates an electronic payment and includes corresponding hardware and software which may comprises a tamper resistant secure element 216 for storing tokens and authentication data to authenticate the master device 210 to the transaction processing server 230, and processes for facilitating an electronic payment through a third party point of sale terminal. In other embodiments, secure element 216 can be any suitable storage element, with different levels or types of security, including a non-secure storage element.

An administration module 214 provides the user of the master device 210 with an administrative interface to manage secure transactions, interface with the transaction processing server 230 and manage account settings and delegations, including adding one or more secondary users and devices and setting resource allocation settings and transaction restrictions. In one embodiment, the administration module 214 is configured to allocate funds to trusted secondary devices through communications link established between the master and a secondary device, and may be initiated by detecting the identity of the secondary device and transmitting a fund allocation instruction to the transaction processing server 230. The fund allocation instruction may be initiated through a user interface on the master device or through interaction with the secondary device 240, such as by tapping the master device 210 to the secondary device 240, or establishing a secure device to device network such as via Bluetooth, Bluetooth low energy (BLE) or a physical connection (e.g., cable). In one embodiment, the master device is associated with a charging location (or other central location) having an NFC touch device where secondary devices can be allocated funds.

Master device 210 further includes at least one communications module 218 adapted to communicate with the transaction processing server 230 and merchant point of sale terminals to facilitate an electronic transaction. In various embodiments, communication module 218 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. The communications module 218 may also be used for other wireless communications, such as tracking the location of the master device 210 via GPS. In various embodiments, communications module 218 may also communicate directly with the secondary device 240 using short-range communications, such as Bluetooth Low Energy, LTE Direct, radio frequency, infrared, Bluetooth, and near field communications (including tap-enabled communications).

Secondary device 240 may be implemented using any appropriate hardware and software and includes a communications module 248 configured for wired and/or wireless communication with master device 210, transaction processing server 230 and merchant point-of-sale terminals. In various embodiments, secondary device 240 may be implemented as a smart bracelet (as illustrated in FIG. 2), a smart phone, tablet, laptop computer, personal computer, wristwatch with appropriate computer hardware resources, head mounted computer (e.g., eyeglasses with appropriate computer hardware), clothing with wearable technology with appropriate computer hardware, and/or other types of computing devices capable of transmitting and/or receiving data as described herein. Although only one secondary device 240 is shown, a plurality of secondary devices 240 may be implemented within the spirit of this embodiment. Moreover, in various embodiments, one or more of the applications, processes, and/or features discussed herein in reference to secondary device 240 may be included in a communication device connected to secondary device 240.

The secondary device 240 also comprises a secure transaction module 242 which is adapted to facilitate a secure transaction with the transaction processing server 230. The secure transaction module 242 comprises a restrictions module 244 and a secure element 246. When a user initiates a secure transaction using the secure transaction module 242 (for example, by tapping an NCF enabled secondary device to an NCF enabled point of sale system), the restrictions module 244 verifies that the proposed transaction is authorized in accordance with account restrictions set by the primary user. If the restrictions module 244 determines that the proposed transaction is authorized, the transaction proceeds using a token and other authentication information stored in the secure element to prepare a transaction specific electronic package which is forwarded to a merchant device of the merchant 260, which forwards the electronic package to the transaction processing server 230 for transaction authorization. The elements of the secure transaction module 242 may correspond to specialized hardware and/or software utilized by the secondary device 240.

The communications module 248 may comprise hardware, software and other components for short-range wireless communication (e.g. a BLE protocol communication) including a “wake up” process for the secondary device 240, near field communication (including tap-enabled), radio communication, infrared communication, and Bluetooth communication. In other embodiments, the communication module 248 may include a broadband device, a satellite device and/or various other types of wired and/or wireless network communication devices including microwave, radio frequency, infrared, Bluetooth, and near field communication devices. The communications module 248 may also be used for other wireless communications, such as tracking the location of the secondary device 240 via GPS or communicating with the network 220.

In various embodiments, secure transaction module 242 may also require a user logon or other form of identification that authenticates the secondary user. The secondary device 240 may include appropriate hardware components for facilitating the user input, such as a keypad, mouse, touch screen, biometric reader or other input device for secondary device 240. In such embodiments, the user may provide an identifier, user account name, password, and/or PIN directly to the secondary device 240. The user may also be identified by secondary device 240 using biometrics and biometric reading devices utilized by the secondary device 240, such as a fingerprint scanner or eye/retinal scanner. Thus, identification information may be entered to device using an interactive touch screen, a keyboard, a mouse, a biometric reader, or other input device for secondary device 240.

In various embodiments, the master device 210 and secondary device 240 may include other applications and features as may be desired. For example, the devices may include security applications for implementing client-side security features, programmatic client applications for interfacing with appropriate application programming interfaces (APIs) over network 220, games, fitness tracking applications, email, texting, voice and IM applications, and other application and features. The communications modules 218 and 248 may also correspond to mobile, satellite, wireless Internet, and/or radio communication applications. The devices may also include financial applications, such as banking, online payments, money transfer, or other financial applications, software programs, executable by a processor, including a graphical user interface (GUI) configured to provide an interface for the user.

Transaction processing server 230 comprises a secure transaction server 232, an account administration module 234, a network interface 238 and database 270 storing account and transaction information. In other embodiments, transaction-processing server 230 may include additional or different modules having specialized hardware and/or software as required.

Secure transaction server 232 may correspond to one or more processes to execute modules and associated devices to process some action taken with regard to use of the secure transaction module 212 or 242. In this regard, secure transaction module 232 may correspond to specialized hardware and/or software utilized by secure transaction server 232 to receive a request to process an action by user 102 when user 102 is utilizing the secure transaction module 212 of master device 210, or when user 204 is utilizing the secure transaction module 242 of the secondary device 240. For example, an action processed by secure transaction server 232 may correspond to a payment to merchant 260. In various embodiments, secure transaction server 232 enforces restrictions on the use of the secondary device 240. If a secure transaction is initiated from the secondary device 240, secure transaction server 232 may verify through the restriction module 236 whether the requested transaction is an authorized use of the user account.

The account administration module 234 interfaces with the secure transaction modules 212 and 242 of the user devices and the account/transaction database 270 to provide a user with access to account information and the ability to configure account preferences. In the illustrated embodiment, the account administration module 234 includes an allocation module 235, which is adapted to allocate available account resources (e.g., money) to a secondary user in accordance with rules established by the primary user. In one embodiment, the primary user allocates a periodic allowance (e.g., $10) to be paid to the secondary user on a periodic basis (e.g., weekly). In another embodiment, the allocation module 235 interfaces with one or more third party application servers, such as application server 280, to track information associated with the secondary user. For example, the secondary user could provide access to a fitness application or school grades. The primary user could set a rule allocating funds to the secondary user based on user-specific events, such as $1 for every 10 miles of running tracked through the fitness application or $5 for every “A” achieved in the classroom.

The restriction module 236 interfaces with the secure transaction modules 212 and 242 to establish and implement restrictions on the secure transactions initiated through the secondary device 240. In various embodiments, restrictions may be geographic (e.g., can only spend money at an amusement park), time and date based (e.g., can only spend on the weekends), use restricted (e.g., can only use the funds to purchase food) and size restricted (e.g., no purchase over $20). The defined restrictions are stored in the account/transaction database 270.

Network interface component 238 is adapted to communicate with master device 210, secondary device 240, merchant 260 and application server 280 over network 220. In various embodiments, network interface component 238 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

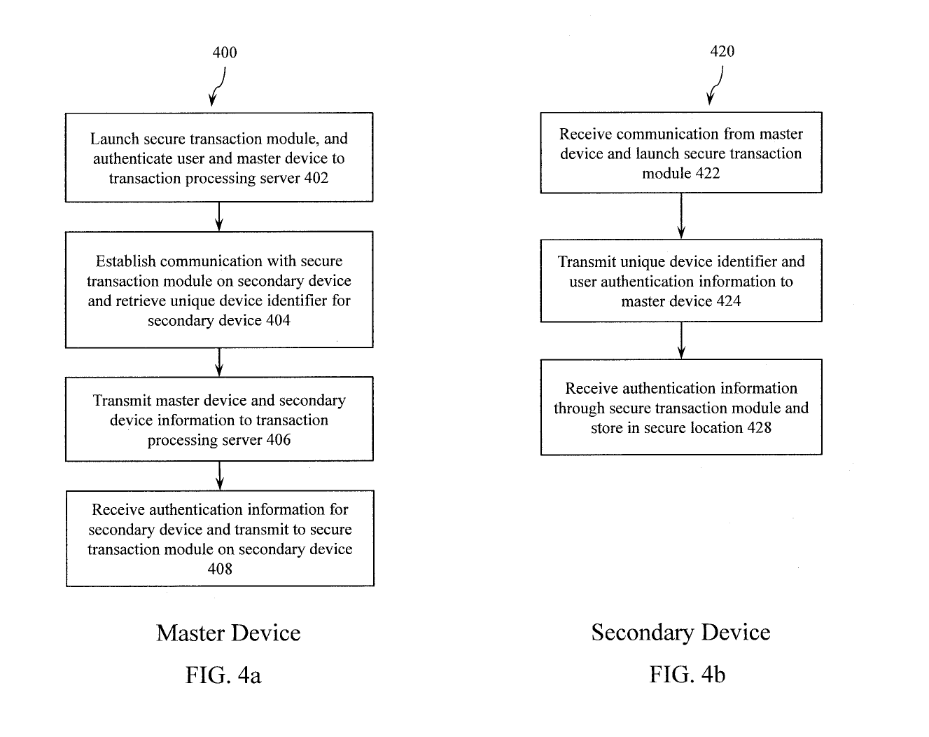

Referring to FIGS. 4a-b, exemplary flow charts for an embodiment of authenticating the secondary user and secondary device for use on the primary user's account is described. In one embodiment, the primary user utilizes the master device to implement the steps of the process 400. In step 402, the user launches the secure transaction module on the master device and authenticates the primary user and primary device to the transaction-processing server. In various embodiments, the primary user may be authenticated though username and password, biometric reading such as a fingerprint scanner or eye/retinal scanner, a user PIN or other security capabilities of the master device. In various embodiments, the master device may be authenticated through a device identifier, a secure token, encryption key exchange or other authentication protocols.

In step 404, the master device establishes communications with the secure transaction module on the secondary device and retrieves unique device identification information for the secondary device. In step 406, the master device transmits encrypted secondary user and secondary device information to the transaction process server for association with the primary user account. The transaction processing server returns authentication information for the secondary device and, in step 408, the master device transmits the authentication information to the secondary device. In one embodiment, the master device and secondary device communicate through the respective secure transaction modules. In an alternate embodiment, the master device configures the account for access by the secondary device and provides the transaction-processing server with contact information for the secondary user, such as a mobile number or email address. The transaction-processing server then sends a message to the secondary device that communicates with the transaction-processing server (bypassing the primary device) to complete the authentication process.

Referring to FIG. 4b, an embodiment of authentication steps 420 performed by the secondary device is shown. The steps of process 420 correspond to the process 400 in FIG. 4a. In step 422, the secondary device receives a communication from the secure transaction module of the master device and launches a corresponding secure transaction module on the secondary device. In step 424, the secondary device transmits a unique device identifier and user authentication information to the master device. In step 428, the secondary device receives authentication information from the secure transaction module of the master device and stores the information in a secure location, such as a secure element. In one embodiment, the authentication information includes a token associated with the primary user's account, and may be used to enter into an electronic payment transaction with funds coming out of a portion of the primary user's account allocated to the secondary user. In various embodiments, one or more tokens may be received and stored for use by the secondary device, single-use or multi-use tokens may be used, and the tokens may be generated and transmitted to the secondary device by the master device or the service provider.

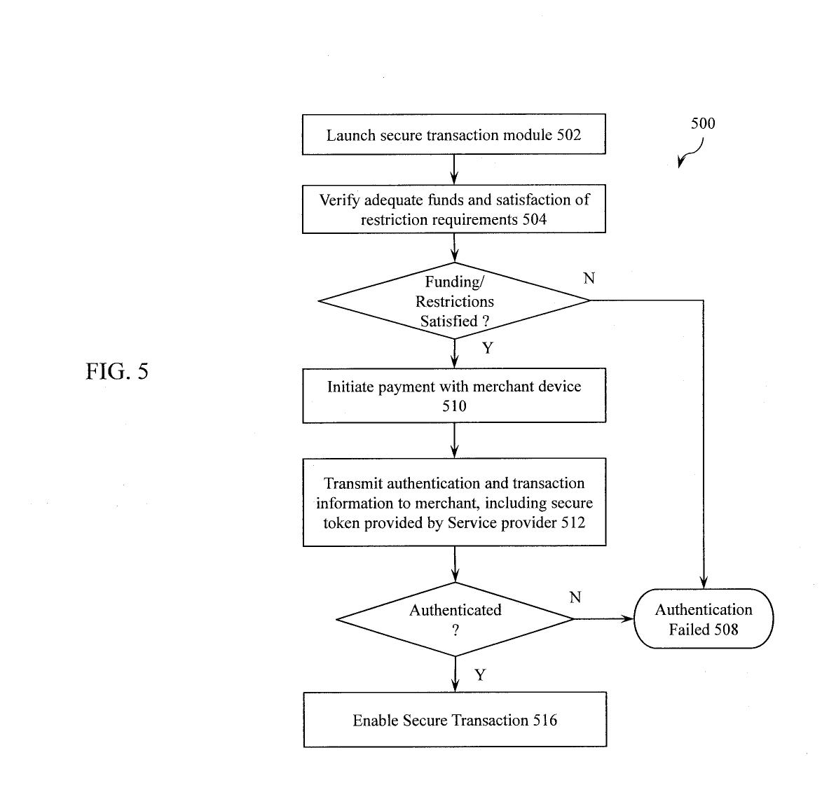

FIG. 5 is a flow chart 500 of an exemplary process for enabling a secure transaction on a secondary device. In step 502, the user launches the secure transaction module on the secondary device. In step 504, the secure transaction module verifies that the proposed transaction is properly funded and meets restrictions placed on the secondary user and device. If there is a lack of available funds or restrictions that prevent the transaction, then the user of the secondary device is notified that authentication for the transaction has failed in step 508. In one embodiment, the user of the master device is also notified when authentication fails, allowing for allocation of addition funds or adjustment of transaction restrictions. If the account is sufficiently funded and account restrictions are satisfied, then the secondary device initiates the payment transaction with the merchant's payment device in step 510.

In step 512, the secondary device generates a secure transaction message from the authentication information stored in the secure element. In one embodiment, the secondary device encrypts a transaction message using an encryption key that is unique to the secondary device and transmits the encrypted transaction message and a token to the merchant. The transaction message may include information identifying the date, time, merchant, item purchased and transaction amount. The token is a unique identifier (e.g, maybe similar to a credit card or gift card number) that associates the transaction to the primary user's account. The transaction message is transferred to the transaction-processing server which deconstructs the message and authenticates the token and that the secondary device is the source of the message. If the message is authenticated, then the payment transaction is authorized to proceed in step 516.

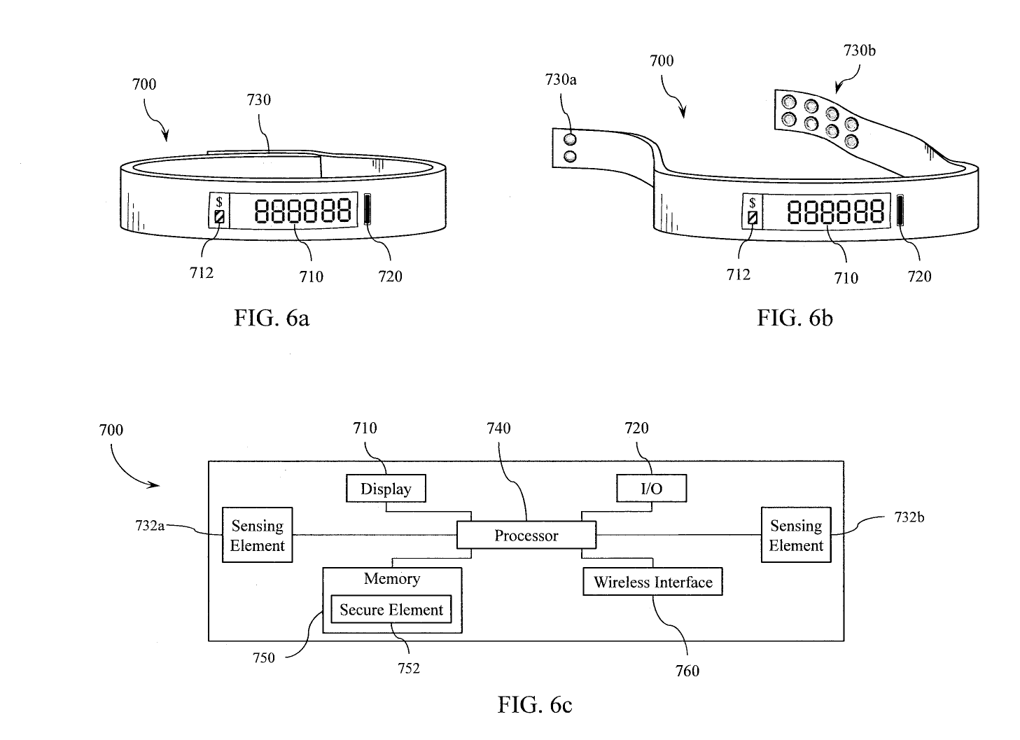

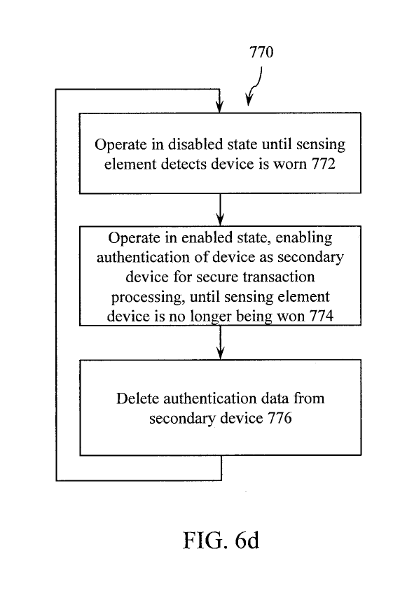

FIGS. 6a-c illustrate an embodiment of a bracelet 700 suitable to function as a secondary device as described herein. The bracelet 700 includes a display 710, input 720 and a fastener 730, which may include adjoining elements 730a and 730b. As illustrated, the display 710 comprises a portion for displaying a dollar balance and one or more indicators 712 such as an icon indicating funds are available or a light or color display to indicate that the bracelet 700 has available funds for payments. The bracelet 700 includes an input 720 allowing the user to select features or actions on the bracelet 700. In various embodiments the input 720 may include one or more buttons used to navigate menu options and select actions, a touch enabled display and/or sensors to detect and enable movement activated inputs. In one embodiment, the bracelet 700 does not include an input 720 and the user confirms a transaction on a merchant's device (e.g., using a merchant PIN pad). The fastener 730 includes two sides that connect together, such as mating snapping elements 730a and 730b. In one embodiment, the fastener 730 is associated with sensing elements 730a and 730b for detecting when the bracelet is being worn.

Referring to FIGS. 6c & 6d, the bracelet 700 further includes a processor 740, a memory 750, including a secure element 752, and a wireless interface 760. In one embodiment, fasteners 730a and 730b are made of conductive metal and serve as sensing elements 732a and 732b, respectively. When the sensing element 732a contacts sensing element 732b, the connection is detected by processor 740, which enables the secure transaction processing on the bracelet (step 772). The primary device may then transfer funds to the secondary device for storage in the secure element 752 of the secondary device. If the bracelet 700 is taken off, the fasteners 730a and 730b are disconnected and the processor detects that the sensing elements 732a and 732b are no longer in contact (step 774). If one if the sensing elements 732a and 732b indicate that the bracelet is not being worn, then the secure element 752 is erased (step 776) and the bracelet 700 is no longer available for payment transactions. In this embodiment, the bracelet 700 may be reactivated by attaching the bracelet 700 to the wrist of a user, and re-authorizing the bracelet 700 through the master device. In one embodiment, the bracelet senses biometric data of a user when it is being worn and the bracelet is disabled when it detects that the biometric data is interrupted (e.g., the device is no longer being worn) or that the biometric data no longer matches the user (e.g., the device is being worn by a new person).

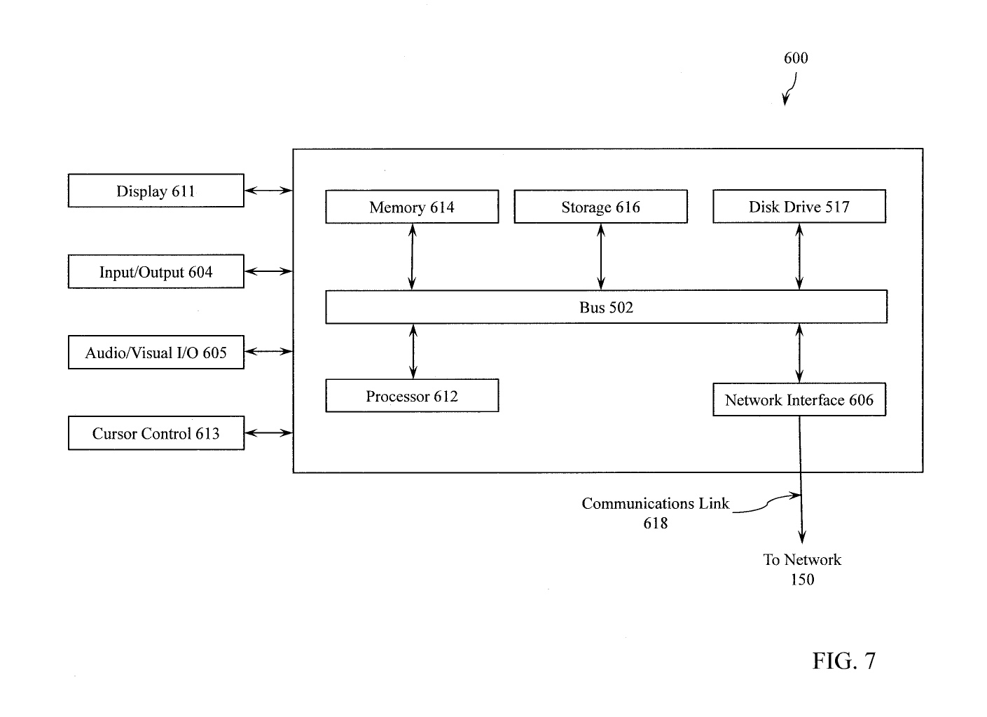

FIG. 7 is a block diagram of a computer system suitable for implementing one or more components described in FIGS. 2, 3 & 6, according to an embodiment. In various embodiments, the trusted user device may comprise a personal computing device (e.g., smart phone, a computing tablet, a personal computer, laptop, a wearable computing device such as glasses or a watch, Bluetooth device, key FOB, badge, etc.) capable of communicating with the network 150. The service provider may utilize a network-computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. In various embodiments, the I/O component 604 includes haptic feedback such as tactile vibration to communicate information to the user (e.g., confirmation of a payment action). A transceiver or network interface 606 transmits and receives signals between computer system 600 and other devices, such as another user device, service device, or a service provider server via network 150. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk or flash drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A wearable device that is enabled via a master device to perform a secure transaction associated with a user, the wearable device comprising:
a sensing element configured to detect a first state indicating the wearable device meets an enabled condition and a second state indicating the wearable device meets a disabled condition;
a storage element configured to store user information for use in the secure transaction; and
a transaction module configured to facilitate a secure transaction process using the stored user information while the wearable device meets the enabled condition, and configured to delete user information stored in the secure element when the wearable device meet the disabled condition.

2. The wearable device of claim 1, wherein the sensing element comprises at least one corresponding pair of adjoining fasteners adapted to secure the wearable device to the user.

3. The wearable device of claim 2, wherein the wearable device meets an enabled condition when the pair of fasteners are in contact, and wherein the device meets a disabled condition when the pair of fasteners are not in contact.

4. The wearable device of claim 1, wherein when the wearable device is enabled, the transaction module is configured to authenticate the wearable device for the secure transaction.

5. The wearable device of claim 4 wherein the transaction module is configured to authenticate the wearable device through a process comprising receiving authentication information from a second device, and storing the received authentication information in the storage element.

6. The wearable device of claim 5, wherein the authentication information includes a token associate with a user account and wherein the secure transaction is an electronic payment process.

7. In an electronic payment system comprising a first user account, a method for provisioning funds from the first user account to a wearable device of a second user for use in a secure transaction, the method comprising the steps:
authenticating the second user and wearable device for use with the first user account;
allocating funds to the wearable device in accordance with at least one allocation rule, the allocated funds having at least one use restriction;
initiating an electronic payment transaction with a portion of the allocated funds; and
processing the electronic payment transaction only if each associated use restriction is satisfied.

8. The method of claim 7, wherein the step of authenticating comprises the steps:
securing the wearable device to the second user;
receiving in the wearable device, authentication information including a transaction token and an encryption key; and
storing the authentication information in a storage element of the wearable device.

9. The method of claim 8, where in the step of authenticating further comprises the steps:
deleting the authentication information from the storage element if the wearable device is removed from the second user.

10. The method of claim 7 wherein the step of allocating funds to the wearable device further comprises the steps:
defining an event based on the achievement of measurable threshold associated with electronically recorded activity of the second user;
tracking the electronically recorded activity of the second user; and
allocating funds from the first user account to the second user and wearable device when the threshold is achieved.

11. The method of claim 7 wherein the step of allocating funds to the wearable device further comprises the steps of:
defining a periodic payment, including a payment amount and frequency of payments; and
allocating funds from the first user account to the second user and wearable device according to the periodic payment schedule.

12. The method of claim 7 further comprising the steps:
defining at least one use restriction, wherein the restriction is one of a location restriction, a time restriction, a merchant restriction and a restriction on how the funds can be spent.

13. The method of claim 7 wherein the step of allocating funds to the wearable device further comprises the step:
receiving a tap from a first user device associated with the first user account, the tap initiating the transfer of funds to the wearable device via near field communication.

14. In an electronic payment system comprising a first user account, a system for provisioning funds from the first user account to a wearable device of a second user for use in a secure transaction, the system comprising:
means for authenticating the second user and wearable device for use with the first user account;
means for allocating funds to the wearable device in accordance with at least one allocation rule, the allocated funds having at least one use restriction; and
means for initiating an electronic payment transaction with a portion of the allocated funds; and
means for processing the electronic payment transaction only if each associated use restriction is satisfied.

15. The system of claim 14, wherein the means for authenticating comprises the steps:
means for securing the wearable device to the second user;
means for receiving in the wearable device, authentication information including a transaction token and an encryption key; and
means for storing the authentication information in a storage element of the wearable device.

16. The system of claim 15, where in the means for authenticating further comprises:
means for deleting the authentication information from the storage element if the wearable device is removed from the second user.

17. The system of claim 14 wherein the means for allocating funds further comprises:
means for defining an event based on the achievement of measurable threshold associated with electronically recorded activity of the second user;
means for tracking the electronically recorded activity of the second user; and
means for allocating funds from the first user account to the second user and wearable device when the threshold is achieved.

18. The system of claim 14 wherein the means for allocating funds further comprises:
means for defining a periodic payment, including a payment amount and frequency of payments; and
means for allocating funds from the first user account to the second user and wearable device according to the periodic payment schedule.

19. The system of claim 14 further comprising:
defining at least one use restriction, wherein the restriction is one of a location restriction, a time restriction, a merchant restriction and a restriction on how the funds can be spent.

20. The system of claim 14 wherein the step of allocating funds to the wearable device further comprises the step:
means for receiving a tap from a first user device associated with the first user account, the tap initiating the transfer of funds to the wearable device via near field communication.
